(19) United States
(12) Patent Application Publication
(10) Pub. No.: US 2016/0271787 A1
(43) Pub. Date: Sep. 22, 2016

(54) DOUBLE-ENDED HAND TOOLS

(71) Applicant: Hubbell Incorporated, Shelton, CT (US)

(72) Inventor: John Edward Sakmar, III, Birmingham, AL (US)

(21) Appl. No.: 14/663,131

(22) Filed: Mar. 19, 2015

(51) Int. Cl. B25G 1/12; B25G 1/10

(52) U.S. Cl. CPC B25G 1/125; B25G 1/102

(57) ABSTRACT

A hand tool includes a handle having a first end and a second end. A first tool extends from the first end of the handle and a second tool extends from the second end of the handle. The first tool is electrically isolated from the second tool.

### BACKGROUND

1. Field

The present disclosure relates generally to hand tools and more particularly to double-ended hand tools.

2. Description of the Related Art

Various types of double-ended hand tools are available. An example of a double-ended hand tool is a basic combination wrench. One end of the combination wrench includes an open-ended box wrench and the other end includes a closed-end box wrench. Generally, each end of the wrench may be dimensioned to fit the same size nut or bolt. Alternatively, each end of the wrench may be dimensioned to fit different size nuts or bolts.

Another example of a double-ended hand tool is a ratchet box wrench having ratchet head sockets provided on each end of the tool. Each ratchet head socket includes a gear wheel having an inner surface including teeth dimensioned to fit a particular size nut or bolt. Generally, each end of the ratchet box wrench is dimensioned to fit a different size nut or bolt.

Another type of double-ended hand tool is a combination of the above-described combination wrench and the ratchet box wrench and is sometimes referred to as a “close quarters” tool. The close quarter's tool includes a ratchet head socket on one end of the tool and an open-ended or closed-ended box wrench on the other end of the tool.

These double-ended hand tools are often formed from one or more sections of iron or hardened steel connecting each end of the tool. These iron or hardened steel sections between the ends of the tool form a handle for the tool. For example, a combination wrench is generally formed from one solid piece of hardened steel with the open-ended and closed-ended box wrenches on either end of a handle. The ratchet box wrench is generally formed from multiple sections of hardened steel having ratchet head sockets on either end of the handle.

One problem with such double-ended hand tools is that the entire tool is electrically conductive. When used in an environment having high voltage or high current conditions, when turning the wrench on a nut or bolt, the other end of the tool may touch an electrical terminal, contact or bare wire, providing a shorting situation. In high voltage or high current conditions, such a situation can be particularly dangerous or deadly for the person holding the wrench.

Another class of double-ended hand tools is available which is formed partially or substantially entirely of composite materials and/or plastic. These tools are relatively cheap to make, are light weight, and provide electrical insulating properties. However, these hand tools also tend to be rather brittle and cannot handle substantial stress and are thus unsuitable for use in certain situations requiring a lot of torque for loosening nuts and bolts.

### BRIEF SUMMARY

The present disclosure provides a hand tool including a handle having at least one outer surface, a first tool extending from the first end of the handle, and a second tool extending from the second end of the handle. The handle includes a first end, a second end and an intermediate portion between the first and second ends. The first end and second end are larger in height than the intermediate portion for preventing a user's hand from slipping from the first and second end of the handle when in use. The first end has an alpha-numeric character formed on the at least one outer surface. The second end has an alpha-numeric character formed on the at least one outer surface. The intermediate portion is formed of an electrically nonconductive material and forms a hand grip between the first end and the second end. The intermediate portion has at least one alpha-numeric character formed on its at least one outer surface.

The present disclosure provides a hand tool handle having at least one outer surface. The hand tool handle includes a first end, a second end and an intermediate portion between the first and second ends. The first end and second end are larger in height than the intermediate portion for preventing a user's hand from slipping from the first and second end of the handle. The first end has an alpha-numeric character formed on the at least one outer surface and an orifice for removably receiving a first tool. The second end has an alpha-numeric character formed on the at least one outer surface and an orifice for removably receiving a second tool. The intermediate portion is formed of an electrically nonconductive material, and forms a hand grip between the first end and the second end. The intermediate portion has at least one alpha-numeric character formed on its at least one outer surface.

### BRIEF DESCRIPTION OF THE DRAWINGS

FIG. 1 is a first side perspective view of a hand tool according to an embodiment of the present disclosure;

FIG. 2 is a perspective view of the hand tool according to an embodiment of the present disclosure with the handle in outline;

FIG. 3 is a cross-sectional view of the hand tool according to FIG. 2 taken along lines 3-3; and

FIG. 4 is a second side perspective view of the hand tool according to FIG. 1.

### DETAILED DESCRIPTION

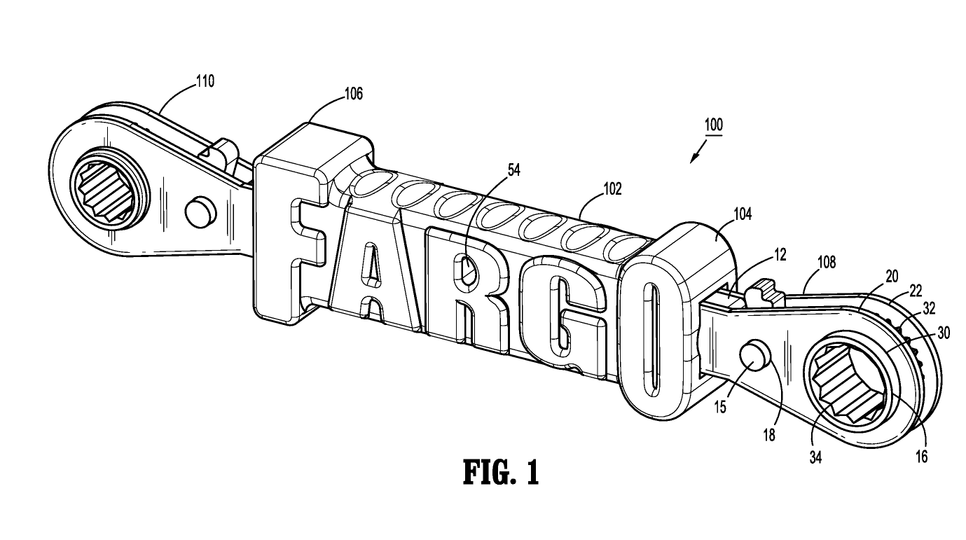

An embodiment of the present disclosure is depicted in FIG. 1 and is referred to generally as wrench 100. According to this embodiment, wrench 100 is a double-ended box-type ratchet wrench. Wrench 100 includes a handle 102. A first end 104 of handle 102 has a box-type ratchet wrench 108 extending therefrom. A second end 106 of handle 102 also has a box-type ratchet wrench 110 extending therefrom. According to this embodiment, ratchet wrenches 108 and 110 are each dimensioned to fit different size nuts or bolts.

Ratchet wrench 108 includes a pair of housings 20, 22 maintained a predetermined distance apart by spacer 12. According to an embodiment of the present disclosure one or more of the housings 20, 22 and spacer 12 may be formed of iron, steel or other type of metal or other rigid material, such as metal. Housings 20, 22 include orifices 30 to receive gear wheels 16. As shown most clearly in FIG. 3, the peripheral edge of gear wheel 16 includes a plurality of gear teeth 32. The inner surface of gear wheel 16 includes flutes or teeth 34 dimensioned to facilitate gripping onto an outer surface of an associated fastener such as a nut or bolt. Pawl 14 has a pivot pin 15 extending from each side thereof. Although only one side of the tool is shown herein, each pivot pin 15 is received in a pivot pin orifice 18 provided through housings 20, 22. Pawl 14 includes a pair of pawl arms 24, 26 extending therefrom as shown. Pawl 14 is capable of rotating about pivot pin 15. When pawl 14 is in the position depicted in FIG. 3, gear wheel 16 is prevented from rotating in the clockwise direction but is capable of rotating and ratcheting in the counter-clockwise direction. When pawl 14 is rotated clockwise such that pawl end 24 is in contact with gear wheel 16, gear wheel 16 is prevented from rotating in the counter-clockwise direction but is capable of rotating and ratcheting in the clockwise direction. One or more springs (not shown) may be provided to maintain pawl 14 in the desired position.

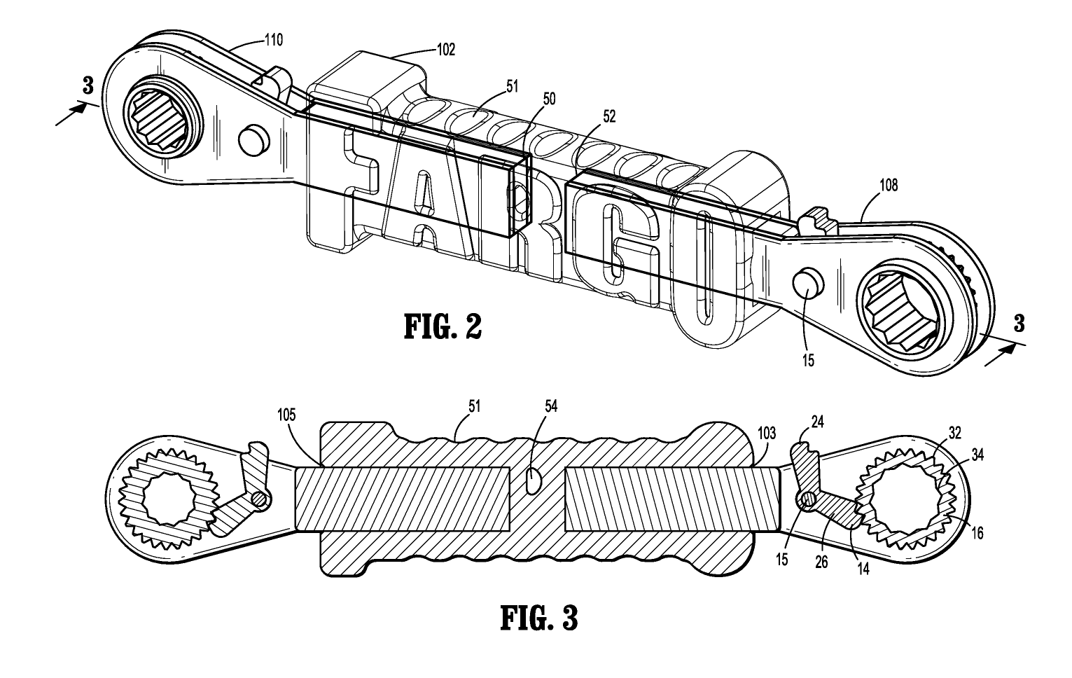

According to embodiments of the present disclosure, the handle 102 has two ends 104, 106 and an intermediate portion between the two ends. The ends of the handle 102 are larger in height than the intermediate portion relative to the longitudinal axis of the wrench 100, as seen in FIG. 2. The handle 102 may include a series of alpha-numeric characters formed on an outer surface the handle or the handle may be formed of a series of interconnected alpha-numeric characters. For example, according to the embodiment shown in FIG. 1, the handle 102 has the word FARGO formed on an outer surface in raised lettering. The lettering provides several benefits. For example, the lettering allows tools to have, for example, the manufacturer's logo prominently displayed on the tool. In addition, as shown, the letters “F” and “O” on each end of the handle 102 are larger and are raised from the rest of the handle and the letters “ARG” in the intermediate portion of the handle. The larger ends of the handle prevent the user's hand from slipping off the end of the tool when in use. The raised lettering on handle 102 or the formed lettering of handle 102, and the series of grooves 51 on the upper and lower surface of the handle, shown in FIG. 2, further provide an ergonomic grip for the user of the tool.

In one embodiment, handle 102 is formed from an electrically nonconductive material. In another embodiment the intermediate portion of the handle is formed of an electrically nonconductive material, and the ends of the handle are formed of an electrically nonconductive material or another rigid material. Non-limiting examples of suitable electrically nonconductive materials include plastics, such as polypropylene materials, Acrylonitrile Butadiene Styrene (ABS), Polylactic Acid (PLA), fiberglass, composite materials, wood, etc. The handle may be formed by injection molding, cast molding, additive processing (e.g., 3-D printing), subtractive processing (e.g., Computerized Numerical Cutting (CNC) processing), etc. As shown in FIG. 2, distal ends 50, 52 of ratchet wrenches 110, 108, respectively, extend only a portion of the way through handle 102. Ratchet wrenches 108 and 110 are thus physically and electrically isolated from each other.

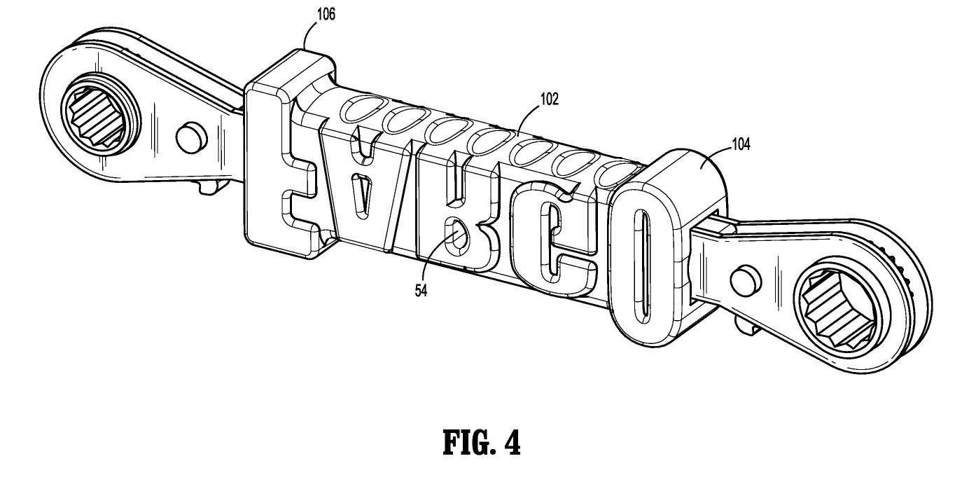

As shown in FIGS. 1-3, a hole 54 extends through the circularly shaped portion of the letter “R” in the handle. Hole 54 extends completely through the handle 102 and provides a window through the handle 102 so the user can see that the metal forming wrenches 108 and 110 do not extend through the handle. Hole 54 may also be used to insert a tool (e.g., a screwdriver) to provide added grip on the tool when in use. Hole 54 may also be used to attach a loop of cord for carrying the tool. In instances where a hole 54 extends through a portion of the logo, for example, the hole extends through the circularly shaped portion of the letter “R” in the handle, the positioning of the hole may impact the configuration of the opposite side letter of the handle 102. For example, as shown in FIG. 4, because the hole 54 extends through the circularly shaped portion of the letter “R” in the handle, the opposite side of the handle has a mirror image of the FARGO logo. Of course, the opposite side of the handle can have no lettering or logo, or the opposite side could have the logo or lettering on the handle so that it is easily read.

According to an embodiment of the present disclosure, ratchet wrenches 108, 110 are permanently attached to handle 102. For example, during manufacture, ratchet wrenches 108, 110 may extend into a handle mold such that distal ends 50, 52 are spaced sufficiently apart. The handle 102 may then be formed by injection molding to form a permanent handle. According to another embodiment, handle 102 may be formed with two geometric openings 103, 105 for removably receiving tools. In this case, the two geometric openings are dimensioned so that distal ends 50, 52 may be removably press fit into handle 102. Alternatively, a locking mechanism (not shown) may be provided for temporarily locking the tools in position once the tools are received in handle 102.

Although described herein with respect to double-ended box-type ratchet wrenches, it will be appreciated that virtually any type or combination of hand tool may be utilized. Non-limiting examples of such tools include ratchet tools, reversible ratchet tools, Allen bar tools, reversible Allen bar tools, penta sockets, 90° penta sockets, 90° penta ratchet sockets, box wrenches, open-ended box wrenches, etc. or any combination thereof.

It will be understood that various modifications can be made to the embodiments of the present disclosure without departing from the spirit and scope thereof. Therefore, the above description should not be construed as limiting the disclosure, but merely as embodiments thereof. Those skilled in the art will envision other modifications within the scope and spirit of the present disclosure as defined by the claims appended hereto.

What is claimed is:

1. A hand tool comprising:
a handle having at least one outer surface, the handle comprising:
a first end having an alpha-numeric character formed on the at least one outer surface;
a second end having an alpha-numeric character formed on the at least one outer surface; and
an intermediate portion between the first end and the second end formed of an electrically nonconductive material, the intermediate portion forming a hand grip between the first end and the second end, the intermediate portion having at least one alpha-numeric character formed on the at least one outer surface; and
wherein the first end and second end are larger in height than the intermediate portion for preventing a user's hand from slipping from the first and second end of the handle;
a first tool extending from the first end of the handle; and
a second tool extending from the second end of the handle.

2. The hand tool as recited in claim 1, wherein the electrically nonconductive material comprises at least one of polypropylene, Acrylonitrile Butadiene Styrene (ABS), Polylactic Acid (PLA), fiberglass, composite materials and wood.

3. The hand tool as recited in claim 1, wherein the first end and the second end of the handle are formed of an electrically nonconductive material.

4. The hand tool as recited in claim 3, wherein the electrically nonconductive material of the intermediate portion comprises at least one of polypropylene, Acrylonitrile Butadiene Styrene (ABS), Polylactic Acid (PLA), fiberglass, composite materials and wood.

5. The hand tool as recited in claim 3, wherein the electrically insulating material of the first end and the second end comprises at least one of polypropylene, Acrylonitrile Butadiene Styrene (ABS), Polylactic Acid (PLA), fiberglass, composite materials and wood.

6. The hand tool as recited in claim 1, wherein one of the at least one alpha-numeric characters formed on the intermediate portion comprises an orifice extending entirely through a section of the alpha-numeric character, providing a window through the handle.

7. The hand tool as recited in claim 1, wherein at least one of the first tool and the second tool permanently extend from the first end and the second end of the handle, respectively.

8. The hand tool as recited in claim 1, wherein at least one of the first tool and the second tool removably extend from the first end and the second end of the handle, respectively.

9. The hand tool as recited in claim 1, wherein the handle is formed by at least one of injection molding, cast molding, additive processing (e.g., 3-D printing) and subtractive processing (e.g., Computerized Numerical Cutting (CNC) processing).

10. The hand tool as recited in claim 1, wherein the at least one alpha-numeric character on the intermediate portion of the handle, the alpha-numeric character at the first end of the handle and the alpha-numeric character at the second end of the handle form a logo.

11. The hand tool as recited in claim 1, wherein the at least one alpha-numeric character formed on the intermediate portion comprises a plurality of alpha-numeric characters in series.

12. The hand tool as recited in claim 11, wherein the plurality of alpha-numeric characters in series on the intermediate portion of the handle, the alpha-numeric character at the first end of the handle and the alpha-numeric character at the second end of the handle form a logo.

13. The hand tool as recited in claim 1, wherein the first end of the handle is formed as an alpha-numeric character, the second end of the handle is formed as an alpha-numeric character, and the intermediate portion is formed as least one alpha-numeric character, wherein the alpha-numeric characters forming the first end, the second end and the intermediate portion of the handle are interconnected to form the handle.

14. A hand tool handle having at least one outer surface, the hand tool handle comprising:
a first end having an alpha-numeric character formed on the at least one outer surface and an orifice for removably receiving a first tool;
a second end having an alpha-numeric character formed on the at least one outer surface and an orifice for removably receiving a second tool;
an intermediate portion between the first end and the second formed of an electrically nonconductive material, the intermediate portion forming a hand grip between the first end and the second end, the intermediate portion having at least one alpha-numeric character formed on the at least one outer surface; and
wherein the first end and second end are larger in height than the intermediate portion for preventing a user's hand from slipping from the first and second end of the handle.

15. The hand tool as recited in claim 14, wherein one of the at least one alpha-numeric characters formed on the intermediate portion comprises an orifice extending entirely through a section of the alpha-numeric character providing a window through the handle.

16. The hand tool as recited in claim 14, wherein the electrically nonconductive material comprises at least one of polypropylene, Acrylonitrile Butadiene Styrene (ABS), Polylactic Acid (PLA), fiberglass, composite materials and wood.

17. The hand tool as recited in claim 14, wherein the first end and the second end of the handle are formed of an electrically nonconductive material.

18. The hand tool as recited in claim 17, wherein the electrically nonconductive material of the intermediate portion comprises at least one of polypropylene, Acrylonitrile Butadiene Styrene (ABS), Polylactic Acid (PLA), fiberglass, composite materials and wood.

19. The hand tool as recited in claim 17, wherein the electrically nonconductive material of the first end and the second end comprises at least one of polypropylene, Acrylonitrile Butadiene Styrene (ABS), Polylactic Acid (PLA), fiberglass, composite materials and wood.

20. The hand tool as recited in claim 14, wherein the at least one alpha-numeric character on the intermediate portion of the handle, the alpha-numeric character at the first end of the handle and the alpha-numeric character at the second end of the handle form a logo.

21. The hand tool as recited in claim 14, wherein the at least one alpha-numeric character formed on the intermediate portion comprises a plurality of alpha-numeric characters in series.

22. The hand tool as recited in claim 21, wherein the plurality of alpha-numeric characters in series on the intermediate portion of the handle, the alpha-numeric character at the first end of the handle and the alpha-numeric character at the second end of the handle form a logo.

23. The hand tool as recited in claim 14, wherein the first end of the handle is formed as an alpha-numeric character, the second end of the handle is formed as an alpha-numeric character, and the intermediate portion is formed as least one alpha-numeric character, wherein the alpha-numeric characters forming the first end, the second end and the intermediate portion of the handle are interconnected to form the handle.
